(19) United States
(12) Patent Application Publication
(10) Pub. No.: US 2026/0356235 A1
(43) Pub. Date: Nov. 12, 2026

(54) BLOCKCHAIN-BASED FRAMEWORK FOR EV CHARGING VIA MOBILE STATIONS

(71) Applicant: Khalifa University of Science and Technology, Abu Dhabi (AE)

(72) Inventors: Tarek El Fouly, Abu Dhabi (AE); Zainab Husain, Abu Dhabi (AE); Rabeb Mizouni, Abu Dhabi (AE); Hadi Otrok, Abu Dhabi (AE); Shakti Singh, Abu Dhabi (AE); Ehab El-Sadaany, Abu Dhabi (AE)

(21) Appl. No.: 19/669,213

(22) Filed: May 6, 2026

Related U.S. Application Data
(60) Provisional application No. 63/800,943, filed on May 6, 2025.

(51) Int. Cl. B60L 53/66; B60L 53/30; B60L 53/53; B60L 53/62; B60L 53/68; G06Q 10/0631

(52) U.S. Cl. CPC B60L 53/665; B60L 53/30; B60L 53/53; B60L 53/62; B60L 53/68; G06Q 10/06315

(57) ABSTRACT

A system can be configured to perform operations for charging electric vehicles. The operations can include receiving charging requests from electric vehicle coalitions. The operations can include determining, for each coalition, a score for the coalition. The operations can include determining, for a first coalition and based on a corresponding score, that a charging permission for the first coalition is acceptable. The operations can include allocating charging resources based on determining that the charging permission for the first coalition is acceptable. The operations can include enabling a charging service to the first coalition by controlling the charging resources. The operations can include adjusting the corresponding score.

### CROSS-REFERENCES TO RELATED APPLICATIONS

This application claims the benefit of U.S. Provisional Application No. 63/800,943 filed May 6, 2025, the entire contents of which are hereby incorporated for all purposes in their entirety.

### BACKGROUND

With global concerns growing over the greenhouse gas emissions, several countries have set plans to phase out internal combustion vehicles in the coming decades. Diverse measures are being taken to encourage the use of EVs by the general public. As more car manufacturers continue joining the EV manufacturing race, the number of EVs on the road has seen a pleasant growth. However, a major concern arises regarding the charging infrastructure needed to support the charging demands of the growing EV population. Some factors limiting the growth of EV infrastructure include economic considerations as well as unresolved issues related to the topics of standardization of chargers, power, and other operational matters.

As the number of electric vehicles (EVs) on the road increases, new and innovative charging solutions are needed to support their energy demand, especially in areas lacking infrastructure, in order to alleviate range anxiety in EV owners. Mobile Charging Stations (MCSs) have emerged as a viable solution, offering on-demand charging by traveling to areas of need. Researchers have explored several allocation mechanisms for MCS dispatch, including energy auctions, which perform well under the assumption that all participants adhere to protocol. However, customer no-shows, which are a common challenge in services, can significantly disrupt MCS operations. The MCS operations can involve stagnation and resource wastage, ultimately reducing the efficiency of charging.

### BRIEF SUMMARY

The present disclosure relates to a blockchain-based framework for charging of electric vehicles (EVs) using mobile charging stations (MCS). The system addresses many challenges including providing charging services in areas lacking traditional charging infrastructure. The system can use a network of MCSs, which can include trucks equipped with battery reserves and charging points. The MCSs can travel to areas with high charging demand to provide charging services. The framework employs a smart contract-based energy trade system that uses a distributed reverse allocation process. In this system, MCS providers can request to provide charging services to EVs. The use of blockchain technology ensures that the interactions are secure, transparent, and tamper-proof. The system also optimizes the allocation and routing of the MCS fleet to ensure efficient deployment and charging services.

In some embodiments, a system can include a processor and a non-transitory computer-readable medium with instructions executable by the processor to configure the system to perform operations. The system can receive a plurality of charging requests from a plurality of electric vehicle coalitions. The system can determine, for each coalition of the plurality of electric vehicle coalitions, a score for the coalition. The system can determine, for a first coalition of the plurality of electric vehicle coalitions and based on a corresponding score, that a charging permission for the first coalition is acceptable. The system can allocate charging resources based on determining that the charging permission for the first coalition is acceptable. The system can enable a charging service to the first coalition by controlling the charging resources. The system can adjust the corresponding score.

In some embodiments, the system can be further configured to execute a smart contract on a blockchain network. The smart contract can be operated to automatically facilitate, validate, and record the plurality of charging requests and resource allocation interactions to provide a tamper-proof, auditable, and transparent record of charging events. Additionally, or alternatively, the score for each coalition of the plurality of electric vehicle coalitions can be computed based on historical behavior of coalition vehicles in attending scheduled charging sessions and prior completion rates of charging interactions, and the score can be dynamically updated after each charging event to reflect coalition behavior. Additionally, or alternatively, the system can be further configured to divide a geographic area of interest into a plurality of spatial zones in which each zone is associated with a local aggregator node, and the plurality of charging requests and resource allocations can be processed locally within each zone using zone-specific interactions to optimize the charging resources.

In some embodiments, the system can be further configured to integrate real-time grid data, traffic data, and mobility patterns into allocation and routing decisions for the charging resources to dynamically respond to changes in charging requests across the plurality of spatial zones. Additionally, or alternatively, the system can be further configured to provide a matching algorithm to enable the plurality of electric vehicle coalitions to be formed. The matching algorithm can include (i) generating a preference list of potential coalition vehicles based on utility functions using input comprising coalition size, scores, and aggregate energy requests and (ii) iteratively updating coalition vehicles according to mutual preferences until stable coalitions are established as the plurality of electric vehicle coalitions. Additionally, or alternatively, the charging resources can include a mobile charging station having a vehicle equipped with at least one battery reserve and a plurality of charging ports. The mobile charging station can be operated to concurrently provide charging services to multiple electric vehicles within a coalition of the plurality of electric vehicle coalitions, and the system can be further configured to allocate the charging resources such that a charging capacity of the mobile charging station is not exceeded.

In some embodiments, the system, after enabling the charging service to the first coalition by controlling the charging resources, can be configured to automatically adjust a score of each coalition member of the first coalition by incrementing the score upon successful charging completion or decrementing the score otherwise. Additionally, or alternatively, the system can be configured to be deployed on a consortium blockchain associated with a plurality of pre-authorized aggregator nodes. Each aggregator node of the plurality of pre-authorized aggregator nodes can be responsible for processing charging requests and recording interactional data within its assigned zone to achieve distributed consensus without a centralized authority. Additionally, or alternatively, the system can be further configured to employ a repeated single-minded bidder (R-SMB) reverse process by receiving sealed requests for charging services, and the sealed requests can be encrypted using a hashing function and revealed only after a predetermined period.

In some embodiments, the system can be configured to dynamically allocate the charging resources between mobile charging stations and fixed charging stations based on real-time availability, capacity, and proximity. Additionally, or alternatively, the system can be further configured to (i) receive encrypted charging requests, (ii) perform decryption and verification on the encrypted charging requests using cryptographic keys, and (iii) execute resource allocation logic to assign the charging resources to coalitions in accordance with smart contract rules.

### BRIEF DESCRIPTIONS OF THE DRAWINGS

FIG. 1 is a diagram of a visualization of zone preferences for mobile charging systems in accordance with certain embodiments.

FIG. 2 is a swim-lane diagram of an allocation process involving mobile charging stations in accordance with certain embodiments.

FIG. 3 is a diagram of a visualization of a progression of an allocation process using a set of requesting electric vehicles and a set of mobile charging stations in accordance with certain embodiments.

FIG. 4 is a diagram of an overview of a coalition-based framework for allocating charging services for electric vehicles in accordance with certain embodiments.

FIG. 5 is a sequence diagram of an allocation process involving coalition building in accordance with certain embodiments.

FIG. 6 is a flowchart of a process for providing charging services based on an allocation process involving coalition building in accordance with certain embodiments.

FIG. 7 is a block diagram of an example of a computing device that can be used to enable charging services using an allocation process in accordance with certain embodiments.

### DETAILED DESCRIPTION

Certain aspects and features of the present disclosure relate to a blockchain-based framework for electric vehicle (EV) charging using mobile charging stations (MCSs). The framework can enable vehicle-to-vehicle (V2V) energy transfer, which can use the surplus energy within an EV population to satisfy the energy requests of EVs in need of charging. In this framework, any EV with surplus energy provide surplus energy reserve to provide flexible charging resources to vehicles most in need. However, other V2V energy transfer networks may have unstable and inconsistent charging levels or availability that can fluctuate over time, can involve inefficient charging for EVs. The blockchain-based framework may be able to stabilize and make more-consistent charging resources in a V2V energy transfer network. The blockchain-based framework may involve deployment of a fleet of dedicated providers, such as a mobile charging station, that can service the energy requests in an area of interest with fewer constraints and with higher charging efficiency and consistency.

A mobile charging station (MCS), such as in the context of a blockchain-based allocation framework, can be used to address the above-described limitations. An MCS can include a vehicle equipped with a large mobile battery reserve and multiple charging ports such that multiple EVs can be charged concurrently. Employing a dedicated fleet of vehicles for the purpose of serving energy requests can allow for better planning and improved EV charging in terms of shorter waiting times, more efficient charging, and so on.

Efficient use of MCS fleets can introduce logistical challenges, among other challenges, such as determining optimal assignments, minimizing service conflicts, and maximizing energy usage efficiency. A particularly disruptive issue based on the foregoing can include failures in EV charging. For example, when an EV does not show up at the designated meeting point for charging, it can result in at least two unfavorable outcomes. The resources of the MCS can be wasted, such as wasted time at the assigned charging point, and the share of resources borne by each EV that does charge increases. Furthermore, as the wasted charging resources could have been better used by another EV, the accumulated failures of a few malicious EVs can affect the quality of service and charging efficiency experienced by other EVs in the vicinity.

An allocation system can enable prioritization of certain EVs, and matching EVs to MCSs, to ensure better resource utilization and more efficient charging for EVs. Additionally, or alternatively, electric vehicles (EVs) may be formed into coalitions with other EVs such as to enable aggregate requests backed by an initial resource transfer to be transmitted to promote more efficient charging for EVs. For example, the allocation system can ensure that MCSs resources can be allocated to EVs with a history of reliability, which can reduce resource wastage, can reduce time wastage, and can increase charging efficiency. The scores can be updated based on EV charging outcomes. Additionally, or alternatively, the coalition formation strategy can work in conjunction with the MCS energy allocation that can allow EVs to be formed into coalitions that maximize utility in the allocation such as through a matching algorithm. The matching algorithm mechanism facilitates coalition formation in which EVs are ranked and can be formed into groups based on mutual preferences and scores. Additionally, or alternatively, an optimized MCS allocation mechanism can be introduced. The improved MCS allocation mechanism can be used to favor larger, higher-scored coalitions, which can maximize resource allocation and charging efficiency. The framework may be distributed so it can be seamlessly deployed on smart contracts, which can enable secure and transparent coalition formation and allocation. The smart contract integration can ensure a reliable and verifiable charging process such as to enhance transparency, foster greater trust in the system, and so on.

In certain embodiments, the system can incorporate a coalition formation mechanism, which can enable EVs to join together to form coalitions such as to enable collective charging requests. Each EV can provide data that can be used to evaluate neighboring EVs based on a utility function that accounts for the potential coalition's size, aggregate energy requests, and scores, which may be the minimum score (e.g., reputation) among coalition members. The coalition formation process may use a matching algorithm in which EVs can be ranked by preference and can be dynamically formed into groups to maximize their utility in the subsequent allocation. Coalitions may be subject to constraints such as maximum size (e.g., up to the number of charging points on an MCS) and aggregate energy requests not exceeding MCS fleet capacity. Coalitions can be reported to an aggregator (AG) for registration and subsequent participation in the allocation process.

The system can involve each EV being assigned a score that can be dynamically updated based on the vehicle's compliance with charging services. Scores may increase when an EV arrives as scheduled and can decrease upon a no-show, subject to upper and lower bounds. When forming coalitions, the coalition's score can be determined as the lowest score among its members. The allocation process can prioritize EVs or coalitions with higher scores, thus favoring reliable participants and reducing resource wastage or time wastage.

To provide seamless charging for EVs, the framework can divide an area of interest (AoI) into zones in which the requests for energy are processed locally, such as in a distributed manner, through energy allocation processes. Matching the EVs to the most suitable MCS can include a nondeterministic polynomial time (NP)-hard problem, and introducing a distributed process can help break it into smaller, more manageable sub-problems. The local energy load can include EVs currently located within the spatial coordinates of the zone, and the charging service providers can be sourced from within the current or neighboring zones. Each zone can host an energy allocation independently such as via a local aggregator (AG). The EVs make themselves known to the AG and can provide data to transmit charging requests based on travel requirements. The requesting EVs can then be served within their respective zone once the allocation process results in their allocation to an MCS. To help manage infrastructure-less charging of EVs, the framework can be deployed on smart contracts on a consortium blockchain. The smart contract can help automate the charging request and fulfillment, and its associated resource transfers with transparency, without the involvement of a third party. The consortium blockchain can be collectively maintained by the pre-authorized AG nodes stationed in each zone. The allocation can be conducted by an AG node within its zone by deploying a smart contract function via the blockchain. After each round of the allocation, information regarding the resultant allocations and associated resource transfers can be aggregated in a block and added to the blockchain after verification. As information stored on a blockchain is immutable, once the information has been added, everyone involved in the interaction can be held accountable such as to promote trust between all participants.

The framework may be managed in a decentralized manner using functions implemented on the smart contracts. The associated allocations and resource transfers can be stored on the consortium blockchain, which can be managed by a group of trusted nodes. A list of symbols used herein is produced below for easy reference:
N is the number of EVs.
M is the number of MCSs.
ERi is the energy requested by EVᵢ.

$${t}_{i}^{chg}$$

is the time needed to charge EVᵢ for required energy.

$${t}_{i}^{chg , full}$$

is the time needed to fully charge EVᵢ (0 to 100%).

$${p}_{j}^{e}$$

is the energy cost per kWh set by MCSⱼ.

$${p}_{j}^{t}$$

is the transport cost per km set by MCSⱼ.

$$S O {C}_{i}^{R}$$

is the required battery status of EVᵢ (%).

$$S O {C}_{i}^{C}$$

is the current battery status of EVᵢ (%).
BCᵢ is the battery capacity of EVᵢ.

The requesting electric vehicles (requesting EV) can be characterized or otherwise identified by their unique ID and their location coordinates that specify which zone they are in at the time of the charging request. The charging requests can be modeled based on their current state of charge

$$( S O {C}_{i}^{C} ) ,$$

battery capacity (bCᵢ), and the desired state of charge

$$( S O {C}_{i}^{R} ) .$$

The mobile charging stations (MCSs) can be or can include trucks or other vehicles equipped with multiple charging points and a battery reserve. The multiple charging points allow the MCSs to serve multiple requesting EV simultaneously. The MCSs can collect information from the AG in their current zone and in neighboring zones and request for providing charging services to the requesting EV can be transmitted accordingly. Upon winning an allocation round, the MCSs can move to their allocated zone to serve the corresponding requesting EV. The local aggregator (AG) can serve as an orchestrator of allocation and the blockchain node within its zone. Each AG can collect the charging requests raised in its zone, can make the information available to the MCSs nearby, can receive requests, can deploy the smart contract to carry out the allocation via the consortium blockchain, can record allocation and interactional information, and can compile it into a block to add to the consortium blockchain. The AG can be implemented as fixed base stations or as vehicle-based mobile nodes that can be temporarily placed at the center of the zones during service times.

Entities associated with the framework can be pre-registered on the system. Upon registration, each requesting EV and MCS can receive a unique ID as well as a public key and a private key. Each requesting EV can provide data that can be used to transmit a single charging request at a time with its unique EV ID. Additionally, or alternatively, each participant can be connected to a single Ethereum address or other suitable blockchain-based address. The public key and the private key can be used for the encryption and authentication for the requesting and resource transfer processes. When in need of charging, a requesting EV in the AoI can provide data that can be used to raise a charging request with the AGs nearby. To prepare the charging request, the requesting EV can provide data, such as an energy amount in kWh, as:

$${E}_{i}^{R} = ( {SOC}_{i}^{R} - {SOC}_{i}^{C} ) \times {BC}_{i} in which {SOC}_{i}^{C} and {SOC}_{i}^{R}$$

are the current and requested SoC of the requesting EV (in percentages), and BCᵢ is its battery capacity in kWh. The charging time, which is the time to be served with the charging resources, and the energy amount, can be calculated as:

$${t}_{i}^{chg} = ( {SOC}_{i}^{R} - {SOC}_{i}^{C} ) \times {t}_{i}^{chg , full} in which {t}_{i}^{chg , full}$$

is the time to charge the EVᵢ from zero to full battery capacity such as via DC charging. Once these parameters have been determined, the charging request, which includes the EV ID, location coordinates, the requested energy amount

$$( {E}_{i}^{R} )$$

in kWh, and the charging time

$$( {t}_{i}^{chg} )$$

in minutes as per the particular EV's battery specifications, can be transmitted. The location coordinates can help determine the zone where the requesting EV is present, and accordingly, the AG responsible for that zone can register the request in its available request list.

A repeated single-minded bidder allocation (R-SMB) may be or include a combinatorial, sealed-request, reverse allocation model in which the service providers can request to earn the right to serve the requests. The R-SMB may include a modification of the single-minded bidder (SMB) allocation that assumes that the requestor is interested in being allocated all items in question, or nothing at all. The SMB can include a computationally efficient process with a comparable performance to the optimal Vickrey-Clarke-Groves (VCG) auction, in terms of maximum welfare in a single round; however, it does not aim towards maximum allocation. To maximize the allocation, the SMB allocation process can be repeated until all requestors are allocated, or the number of requesting items is exhausted, which can result in the framework of the R-SMB. A pool of service (charging) requests can be collected that need to be assigned to a group of MCSs. The processing relating to R-SMB can be held at regular intervals as long as there are pending charging requests outstanding. At the beginning of each round, information regarding the pool of charging requests can be made available to the MCSs, or other suitable computing system, after which the requesting and R-SMB processing commences. One round of the R-SMB processing can proceed according to the following steps.

The MCSs can collect information regarding the charging requests from the AG and requests can be generated as the remaining SoC of their battery reserve and physical charging capacity allows. Information on the available charging requests can be accessed by making a call to the getRequests( ) function. The getRequests( ) function can return a list of charging requests, specifying the zone_{id},

$${E}_{x}^{R}$$

and the charging time

$${t}_{x}^{chg}$$

of each requester EVₓ. To optimize the distance traveled by the MCS while providing the charging service, a request can focus on a group of EVs in a current zone or in neighboring zones with respect to the MCS. If there are no charging requests identified in preferred zones, the preference can be gradually relaxed to include further away zones until a requesting list is formed.

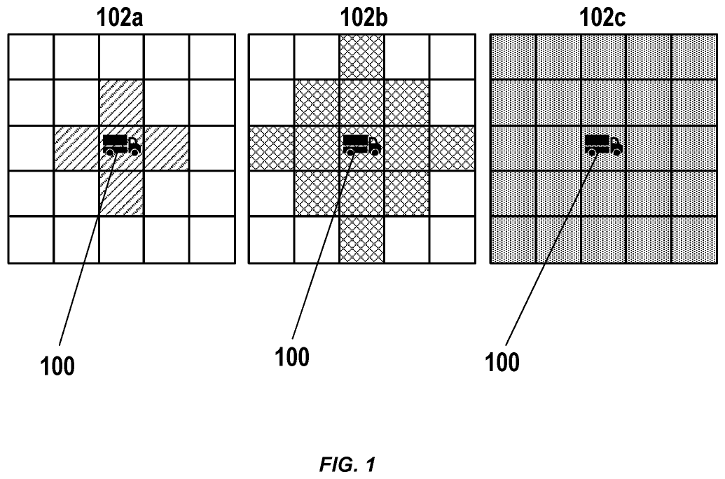

FIG. 1 is a diagram of a visualization of zone preferences for mobile charging systems (MCSs) in accordance with certain embodiments. As illustrated in FIG. 1, the zone preference for an MCS 100 may begin with preference A 102a that includes five zones preferred, which include the MCS' own zone and four neighboring zones that are shaded in FIG. 1. If this zone selection fails to produce candidate EVs for requesting charging resources, the zones can be updated to include zones up to two zones away from the MCS 100, as in preference B 102b. This continues until all zones are included in the preferred zones list, such as in preference C 102c or until no more pending requests are identified in the AoI. Once the MCS 100 has gathered information from its preferred zones, a list of possible requests, bid_listᵢ, can be generated. As each MCS can have multiple charging points, a possible request for any zone can include a combination of up to n number of charging requests from that zone that can be satisfied with the current SoC of the MCS's battery reserve. If the MCS 100 is already allocated and currently charging a requesting EV, the MCS 100 can still rejoin the allocation based on a request for any free charging points. However, in this case, the MCS 100 may be limited to requesting EVs within the zone the MCS 100 is currently located.

The resource allocation associated with a request formed with a combination of charging requests from the same zone (zone_{b}) can be calculated as follows: bid=cost_{energy}+costₜᵣₐᵥₑₗ in which

$${cost}_{energy} = {p}_{j}^{e} \times {\sum }_{i = 1}^{m} {E}_{i}^{R}$$

$$and$$

$${cost}_{travel} = {p}_{j}^{t} \times {D}_{a , b} .$$

In some embodiments, m is the number of EV requests included in the request, while

$${E}_{i}^{R}$$

is the energy requested (in kWh) for each EVᵢ included in the request. D(a,b) can include the Manhattan distance between the meeting points of zones a and b, where zone a is a current zone of the MCS 100 and zone b is the zone for which the MCS 100 is requesting. No transport cost is involved if the request is for a current zone of the MCS 100. Parameters

$${p}_{j}^{e} and {p}_{j}^{t}$$

may be a request for resources associated with energy per kWh energy and the travel cost per km, respectively. After evaluating request combinations, the bid_list can be sorted to determine the optimal requesting option, which can be transmitted as a final request for that round.

Each finalized request can be transmitted to the AQ through a call to the submitBid( ) function that can send the request information to the smart contract. The data can be transferred as plaintext, which makes it visible to other MCSs. However, the data may be sealed in some processes to promote truthfulness. To implement sealed data, an additional step involving encryption of the data using a hashing function can be used. The encryption can be performed by passing the data (BIDⱼ), and a random token rᵢ to a hashing function that returns the value hᵢ as in: hⱼ=HASH(BIDⱼ, rⱼ). The MCS can submit [BIDᵢ, hᵢ] as sealed data. The sealed data is registered under the MCS' identity and revealed only after the requesting period (t_{Bid Reveal}) ends. To reveal the sealed data, the MCS 100 can share rᵢ with the revealBid( ) function, which can compute HASH(BIDⱼ, rᵢ) to confirm that it is the same as the hᵢ value initially submitted by the MCS 100 while transferring the data. The data can be included in the allocation if the hash values are found to agree, and discarded otherwise. The hashing can be executed using functions like keccak256( ), sha3( ) or ripemd160( ) in solidity with a reasonable on-chain cost.

After the t_{Bid Reveal} time event has passed, and the authenticated requests can be revealed and collected, a round of allocation can be performed in each zone based on the R-SMB processing rules. To perform the allocation, the requests can be normalized as follows:

$${B}_{j} = \frac{{BID}_{j}}{\sqrt{{s}_{j}}} ,$$

in which BIDⱼ is the request associated with MCSⱼ, sⱼ is the size of the request, and Bⱼ is the calculated rank for MCSⱼ's request. After normalization, the requests can be sorted, such as in ascending order, based on their ranks, and the AQ may be responsible for determining the set of winners for the allocation round. The requests can be sorted in ascending order to ensure that the requesting EVs get the best charging services. After the sorting, the AQ can perform the allocation from the sorted list in a top-down approach in which a requestor under consideration can become a winner if the corresponding request does not intersect with the set of already allocated tasks. Once declared a winner, the set of request tasks can be added to the set of allocated tasks before continuing down the list of remaining requests. The process is continued until all requests are analyzed, after which the set of winners can be announced.

Each round of the R-SMB allocation finds the winner MCS for the current set of charging requests in the area and is repeated until (i) all requests are assigned, (ii) all MCSs are allocated, or (iii) the mechanism exceeds the pre-defined roundsmax threshold on the number of iterations. The winner can be provided with a critical resource transfer to help maintain rank. To determine the critical resource transfer for an allocated MCS, the requests associated with other MCSs can be analyzed. In some embodiments, the allocation process can be repeated, such as at regular intervals, until one of the following termination conditions is met: (i) all waiting requests from requesting EVs are completed, or (ii) all MCSs run out of battery capacity.

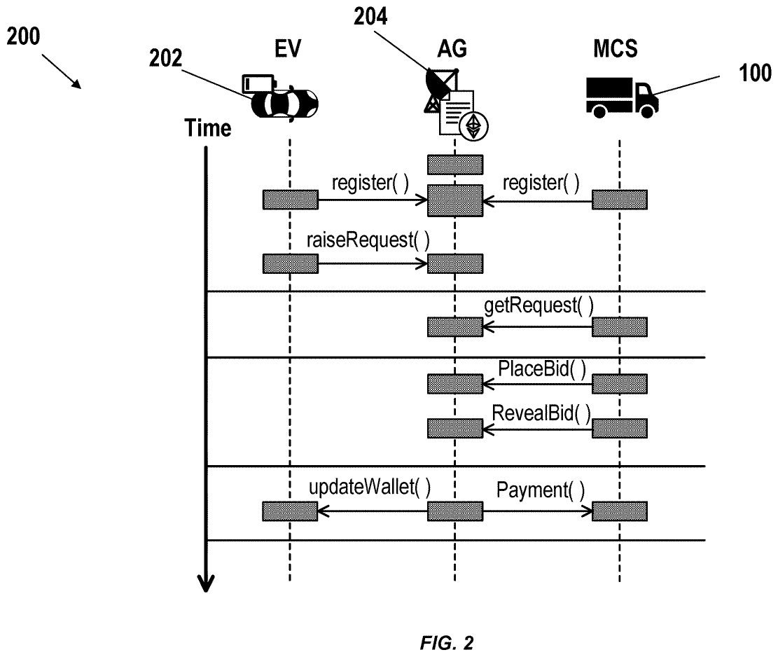

FIG. 2 is a swim-lane diagram of an allocation process 200 involving mobile charging stations (MCSs) in accordance with certain embodiments. As illustrated in FIG. 2, the allocation process 200 may involve a requesting EV 202, an AG 204, and an MCS 100, though other components, or other numbers of components, are possible to substitute for those illustrated in FIG. 2. The requesting EV 202 may include an electric vehicle associated with a request for charging services from an MCS, the MCS 100 may be included in a set of MCSs that are able to provide charging services for EVs, and the AG 204 may include an entity that is able to facilitate charging services and use a blockchain to facilitate providing the charging services.

The allocation process 200 may begin with the requesting EV 202 and the MCS 100 registering with the AG 204. Registering with the AG 204 may involve providing identifying information, providing requested charging specifications, providing provider charging specifications, etc. The AG 204 may register the requesting EV 202 and the MCS 100 and may field requests for charging services such as by the requesting EV 202. Afterward, or otherwise without respect to the AG 204 fielding requests for the charging services, the AG 204 can receive requests by MCSs, such as the MCS 100, to identify or otherwise receive the requests for charging services. The AG 204 may allow the MCS 100, or others of the MCSs, to place requests for charging resources, whether public or encrypted as sealed data, as described above. The AG 204 can resolve the information provided by the MCS 100 and other MCSs, if applicable, and the AG 204 can select a combination of requesting EV and MCS to engage in an interaction involving charging services. The AG 204 can record the interaction and facilitate resource transfer for facilitating the interaction using the blockchain.

The processing illustrated in FIG. 2 can be implemented on a smart contract with a group of functions. The requesting EV 202 can transmit new charging requests by making a call to the function raiseRequest( ) to the AG 204, in which they share their location coordinates and their charging request, along with an initial resource transfer for the charging service. At the beginning of each allocation round or cycle, the MCS 100 can access the available charging requests in each zone through the getRequests( ) function call to the AG 204. A request by the MCS 100 can be transmitted through a call to submitBid( ) to the AG 204, in which encryption of the data is shared. Once requests have been verified, the AG 204 can initiate the allocation of charging resources by making a call to the RSMBAllocation( ) function. This step can include two sub-steps that can include allocation and resource determination. The calculated critical payments can be transferred to the MCS 100 from the amounts initially provided by the requesting EVs (function call Payment( ) while the remaining amount can be returned to the requesting EVs by making a call to UpdateWallet( ) The AG 204 may record the foregoing using the blockchain.

The described framework can be implemented as a set of smart contracts deployed on a consortium blockchain. The smart contracts can manage the full lifecycle of charging requests, coalition formation, allocation execution (including sealed requesting and request revelation), allocation, and resource transfers. Each participant (EV, MCS, AG) can be assigned a public/private key pair for secure authentication and interaction signing. The consortium blockchain can provide a transparent, tamper-proof record of all actions, which can enable trustless operation and facilitating automatic enforcement of allocation and transfer rules. Examples of smart contract functions can include raiseRequest, getRequests, submitBid, revealBid, RSMBAllocation, Payment, and UpdateWallet, though others are possible.

The use of the repeated single-minded bidder (R-SMB) allocation in the system can provide allocation quality comparable to the optimal Vickrey-Clarke-Groves (VCG) auction but at dramatically reduced computational cost, enabling practical deployment on blockchain-based smart contracts. The system can achieve high energy charging satisfaction rates, reduced average waiting times for EVs, and lower resource costs as compared to traditional, centralized, or less sophisticated allocation mechanisms. The coalition and scoring mechanisms further minimize wasted MCS service time and improve overall charging efficiency.

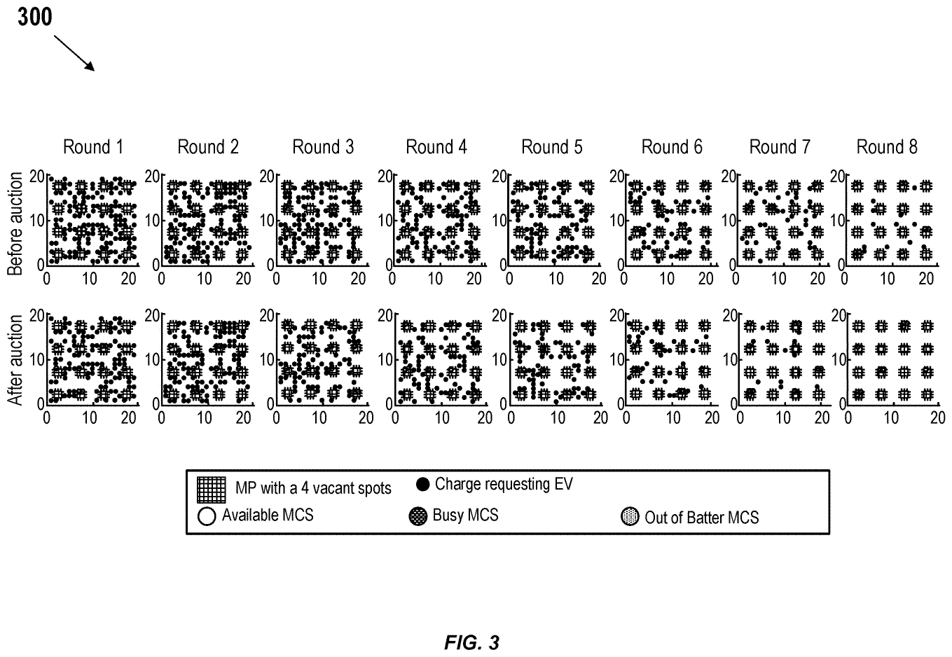

FIG. 3 is a diagram 300 of a visualization of a progression of an allocation process using a set of requesting EVs and a set of mobile charging stations in accordance with certain embodiments. In some examples, FIG. 3 illustrates multiple graphs corresponding to geographic locations of MCSs and requesting EVs. As an allocation process progress, such as top-to-bottom and left-to-right, the requesting EVs are linked with MCSs to conduct charging interactions. The allocation process may continue until there are no requesting EVs left, no battery capacity from MCSs, etc.

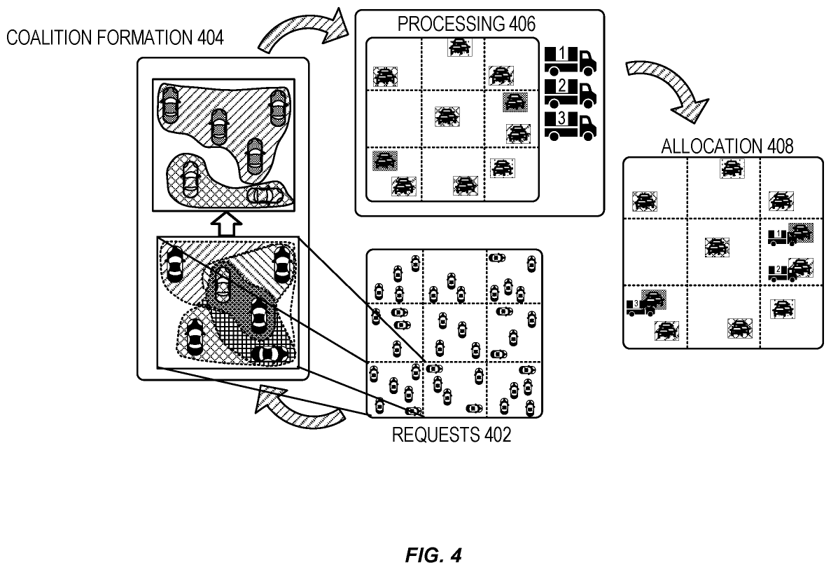

FIG. 4 is a diagram of an overview of a coalition-based framework for allocating charging services for electric vehicles in accordance with certain embodiments. As illustrated in FIG. 4, the coalition-based framework may proceed from requests 402, to coalition formation 404, to processing 406, and to allocation 408. To enable coalition formation among EVs, a matching algorithm can be conducted. To participate, the requesting EVs can start by providing information that can be used to analyze neighboring EVs and to rank the neighboring EVs based on their suitability as coalition partners. This ranking can be determined through a systematic analysis in which the utility of each potential coalition is calculated, and the corresponding payoffs for each participant can be determined. The preference list can be used to optimize chances of forming beneficial coalitions such as coalitions with highest charging rates, highest charging success, highest charging efficiency, and so on. The requesting EVs may be formed into coalitions to (i) maximize the size of the coalition, up to a maximum, which is the number of EVs a MCS can charge concurrently, (ii) maximize the score of the coalition, which is the lowest of the scores of the coalition members, and (iii) keep the aggregate energy request of the coalition below the charging capacity of the available MCS fleet.

The conditions can be incorporated into the EV's utility function, given by Equation 1:

$$utility ( {c}_{i} ) = \{ \begin{matrix}0 , & if E ( {c}_{i} ) > limit \\ {w}_{1} \times \frac{s ( {c}_{i} )}{S} + {w}_{2} \times \frac{r ( {c}_{i} )}{R} , & otherwise\end{matrix} \qquad ( 1 )$$

in which Cᵢ is the coalition under consideration, s(cᵢ) and r(cᵢ), as in Equation 2, are the size and score of the coalition cᵢ, while C and R are the upper limits on the possible values of coalition size and score in the system. The score of a coalition can be calculated as the minimum of the scores of the members involved, as defined below in Equation 2:

$$r ( {c}_{i} ) = {min}_{∀ m ∈ {c}_{i}} Rep ( m ) \qquad ( 2 )$$

in which Rep(m) is the score of member m. Furthermore, the aggregate energy request raised by the coalition can be defined as in Equation 3:

E(cᵢ)=Σ_{∀vm∈c}_{ᵢ}E(m) (3)

in which E(m) is the energy request of member m. Neighbors can be sorted in decreasing order of their shapely values.

Once the neighbor preference lists have been generated, a new round of the matching algorithm can begin. For example, suppose there are N EVs in a zone. A quarter of the requesting EVs can randomly, or pseudo-randomly, be assigned or otherwise selected as leaders to initiate the coalition formation process, with the selection starting from the requesting EVs with the highest scores in the zone. EVᵢ, one of the chosen leaders, can begin the game by providing information to analyze its preference list and to check availability of most preferred neighbors. The highest ranked, available requesting EV, such as EVⱼ, on the list can be requested to be added to a coalition. The request may be approved, and EVⱼ may be added to the coalition. To avoid infinite loops, coalition requests can be considered in order of arrival. In case the requesting EV receives multiple coalition requests at the same time, the request associated with the highest ranked neighbor can be reviewed and potentially accepted before others. The next available candidate from the preference list can be identified, and a suggestion can be made, such as to all coalition participants, to add the next available candidate. The process can repeat until there are no more candidates left to consider. Finally, any requesting EVs that fail to be added to a coalition can remain in the pool as individual charging requests, and can be requested for separately, or can be aggregated with other requests.

The selection of the parameter n, which is the cut-off on the ranked neighbor list of each requesting EV, can be analogous to the pickiness of the requesting EVs, or can otherwise control the growth of the coalition. If relaxed, such as if n is close to or equals N, most or all coalitions may stabilize at the maximum coalition size. On the other hand, if n is set to a lower value, the coalitions may stop at much smaller sizes, with several requests from requesting EVs as individual requests in the energy charging process such as coalition size=1. Smaller coalitions may struggle to be served in the allocation process due to the lack of aggregated energy requested. Larger coalitions may be prioritized that engage more charging points and promise higher charging use. Additionally, or alternatively, smaller coalitions or individual requesting EVs might experience delays or reduced chances of receiving charging service, especially if the requests for MCS resources exceeds that which is available.

In some examples, the coalition formation process may use a matching algorithm. Each EV, upon learning of neighboring EVs' requests, can provide information that can be used to generate a preference list based on utility functions that consider coalition size, score, and aggregate energy requests. A subset of EVs is randomly (or pseudo-randomly) selected, or selected based on scores, as coalition leaders. The leaders can cause preferred neighbors to join the coalition, subject to mutual preference and coalition constraints. The process can continue iteratively, with coalition adjustments implemented or rejected based on each EV's preference list, until stable coalitions are formed. Any requests from EVs not in a coalition can be treated as individual requests in the allocation process.

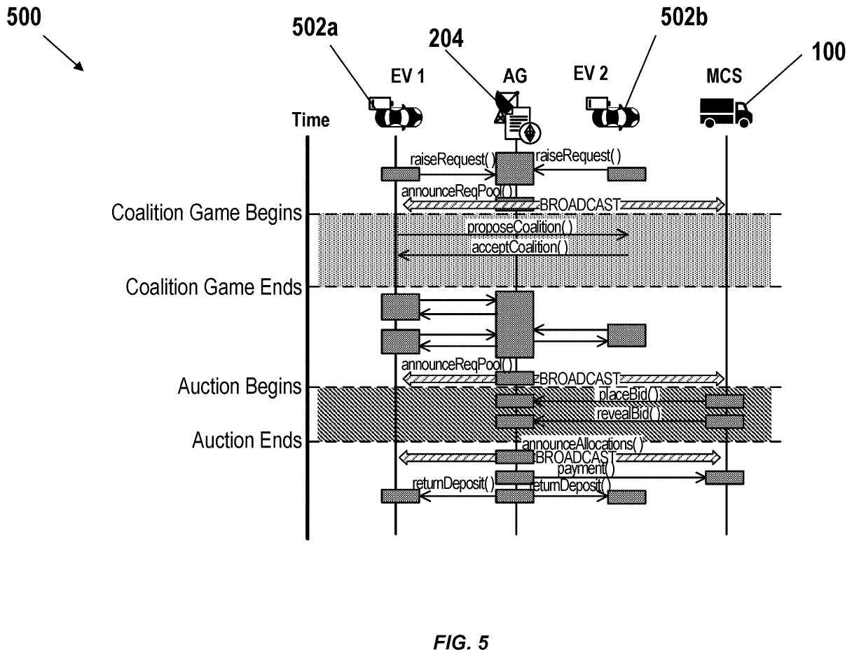

FIG. 5 is a sequence diagram of an allocation process 500 involving coalition building in accordance with certain embodiments. The allocation process 500 may be represented by a swim-lane diagram involving a first requesting EV 502a, a second requesting EV 502b, the AG 204, and the MCS 100, though other components or entities may be substituted for those illustrated in the allocation process 500. The allocation process 500 may commence once new charging requests are registered in the system with the AG 204. In order to raise a new charging request, a requesting EV, such as the first requesting EV 502a and/or the second requesting EV 502b, can indicate the amount of energy it is requesting

$$( {E}_{i}^{R} ) ,$$

or this information can be determined by a third party system, and the associated charging time

$$( {t}_{i}^{chg} )$$

to receive the energy transfer based on battery specifications, along with its unique EV ID and location coordinates. The request is broadcasted and can be added to the request list of the AG 204 responsible for that zone.

Once the new request list is compiled, the new request can be broadcast to the requesting EVs within the zone to inform of their neighbors. Using this information, preference lists for the requesting EVs can be constructed, and the preference lists can be used in the matching algorithm. At the conclusion of the matching algorithm, some requests can be grouped into coalitions, while others may remain individual, depending on each requesting EV's determined utility within its neighborhood. Each newly established coalition can be reported to the AG 204 by its leader EV such as the requesting EV that initiated the coalition. Upon receiving the new coalition announcement, the AG 204 confirms the announcement by sending back an acknowledgment. The coalition vehicles can transfer a pre-set resource amount to the AG 204 as an initiation term for a request from the coalition. The resource amount may be returned if the corresponding requesting EV arrives at the designated charging location and receives charging resources. However, failure to receive the charging resources may result in a deduction from the resource amount for inconvenience (e.g., lower charging efficiency, time wastage, etc.) caused by the failure. Once the EVs conclude the resource transfers, the AG 204 can transmit another acknowledgment, which confirms the formation of the coalition. The confirmed coalition can be appended to the new request list. By the end of the coalition matching process, the request list can include coalition requests and individual requests.

The new request list can be broadcasted within the region and can serve as the commodity list for the energy allocation process. Each MCS can formulate a request for the cycle by assessing its current resource status and the request list. The MCSs may maximize the energy it provides from its available reserve and the number of charging points deployed. As a result, aggregated requests may be prioritized with a larger requesting EV list and higher energy requests, provided they fall within a charging resource capacity. Additionally, The reputation of the selected request aggregates can be maximized, whether coalitions or individual requests, favoring candidate requests with a history of successful allocation execution. This strategic selection helps enhance projected resource utilization of the MCS 100 for the cycle. If the MCS 100 is already allocated and currently charging a requesting EV, the MCS 100 can rejoin the allocation process with a request for any free charging points. However, in this case, the MCS 100 may be limited to requesting EVs within the zone where the MCS 100 is located.

To finalize a request for the round, the MCS 100 can analyze options and can generate a candidate list. The MCS 100 may begin by scanning the requests in its preferred zones. The preferred zone list can be initialized to the MCS's current zone and a predetermined number, such as four, of immediate neighboring regions. If no requests are found in this range, the preferred zone range can be gradually expanded until it covers the entire AoI. The produced list of candidate requests can be sorted, such as in descending order, in terms of the requests' scores, followed by the total charging provided from the charging requests. This way, the MCS 100 can be assigned the most beneficial charging request with the requesting EV with a highest likelihood of success.

The scores of the requesting EVs can be updated using Equation 4:

$$Reputation ( {EV}_{i} ) = \{ \begin{matrix}- 1 , & if no - show \\ + 1 , & if showed up\end{matrix} \qquad ( 4 )$$

If a requesting EV arrives as scheduled, its score can be increased by 1, and if the requesting EV fails to show up or otherwise does not receive the charging services, its score may decrease by 1, while remaining within predefined upper and lower limits of the score scale. This score update can mark the conclusion of a cycle of the allocation process. Any coalitions that were not served in the cycle may be dissolved, and the process may repeat for the next cycle. The allocation process 500 may run every 15 minutes, or other suitable time repetition, and may continue until all charging requests are fulfilled or the maximum threshold is met. The time interval at which the allocation process 500 repeats can be fine-tuned to the necessity/utility of the specific area.

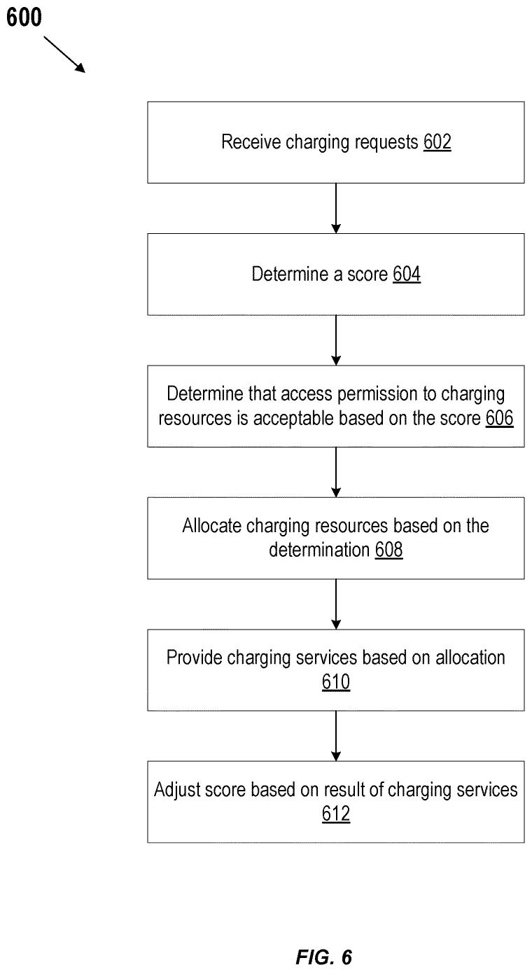

FIG. 6 is a flowchart of a process 600 for providing charging services based on an allocation process involving coalition building in accordance with certain embodiments. At block 602, charging requests are received. The charging requests may be received by a mobile charging station, an aggregator, or other suitable system. The charging requests may originate from one or more electric vehicle coalitions or vehicles or computing devices thereof.

At block 604, a score is determined. The score may be determined based on processing performed to analyze each coalition vehicle for each electric vehicle coalition. A score may describe or represent an electric vehicle coalition as-a-whole, and the score may be based on individual scores of coalition vehicles. In some examples, the score, which may include a reputational score, for an electric vehicle coalition may be a minimum of the individual scores of the coalition vehicles, etc. The score may be based on past behaviors associated with the coalition vehicles, past outcomes of charging services, or other suitable factors.

At block 606, a determination regarding whether a charging permission for a coalition is acceptable is made. The determination may be performed for each coalition, in addition to the coalition, of the electric vehicle coalitions and may be based on a corresponding score. At block 608, charging resources are allocated. In some examples, the charging resources can be allocated from the mobile charging station based on the determination at the block 606. Allocating the charging resources may include providing access, or charging permission, to coalition members of the coalition to charge such as by using one or more charging outlets of the mobile charging station.

At block 610, charging services are enabled to the coalition. Enabling the charging services can include transferring electricity from the mobile charging station to the coalition members. In some examples, charging resources may be controlled by allowing the electricity to flow, capping electricity flow, and so on. At block 612, a corresponding score is adjusted. If the coalition members successfully use the charging services, the score may be incremented, and if not, the score may be decremented.

In some embodiments, the system may allow for variable coalition sizes, different score update rules, or alternative allocation mechanisms such as hybrid models combining fixed and mobile charging infrastructure. The initial resource transfer enforcement may be replaced or supplemented by other forms of incentives such as service priority or resource reduction. The system may also be adapted for integration with real-time grid data, traffic conditions, or user mobility models to further optimize MCS deployment and resource allocation.

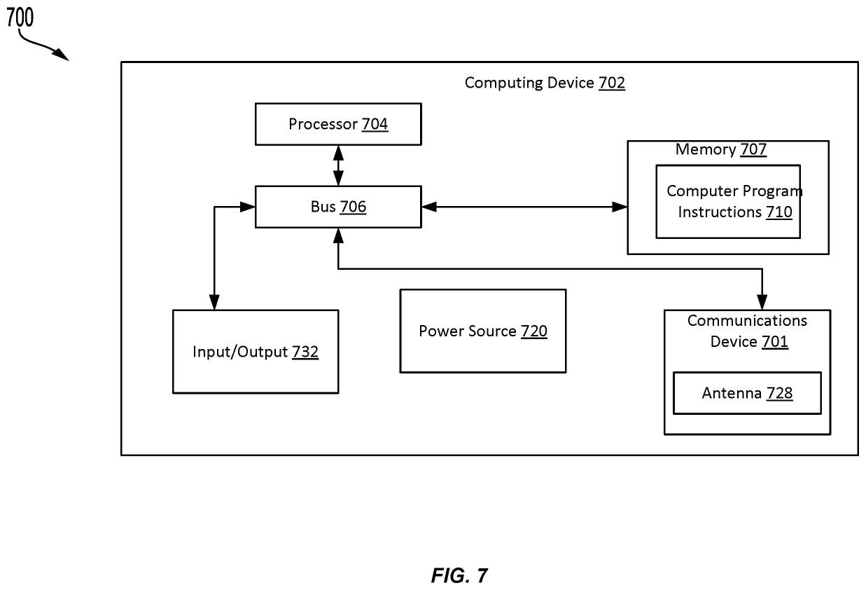

FIG. 7 is a block diagram of an example of a computing device 702 that can be used to enable charging services using an allocation process in accordance with certain embodiments. The components illustrated in FIG. 7, such as a processor 704, a memory 707, a power source 720, a communications device 701, etc., may be integrated into a single structure, such as within a single housing of a computing device 702, which may be or include a mobile computing device such as a smartphone, may be or include a computing device associated with an MCS, EV, or AG, etc. Alternatively, the components shown in FIG. 7 can be distributed from one another and in electrical and/or data communication with each other.

The computing system 700 may include the computing device 702. In some embodiments, the computing device 702 may be or include a mobile computing device, such as a smartphone, though other suitable examples of a mobile computing device are possible. The computing device 702 can include the processor 704, the memory 707, which may be non-volatile, and a bus 706. The processor 704 can execute one or more of the operations disclosed herein, for example, relating to the charging resource allocation. The processor 704 can execute instructions stored in the memory 707 to perform the operations. The processor 704 can include one processing device or multiple processing devices or cores. Non-limiting examples of the processor 704 can include a Field-Programmable Gate Array (“FPGA”), an application-specific integrated circuit (“ASIC”), a microprocessor, etc.

The processor 704 can be communicatively coupled with the memory 707 such as via the bus 706. The memory 707 may include any type of memory device that retains stored information when powered off. Non-limiting examples of the memory 707 may include EEPROM, flash memory, or any other type of non-volatile memory. In some examples, at least part of the memory 707 can include a medium from which the processor 704 can read the instructions. A computer-readable medium can include electronic, optical, magnetic, or other storage devices capable of providing the processor 704 with computer-readable instructions or other program code. Non-limiting examples of a computer-readable medium can include magnetic disk(s), memory chip(s), ROM, RAM, an ASIC, a configured processor, optical storage, or any other medium from which a computer processor can read instructions. The instructions can include processor-specific instructions generated by a compiler or an interpreter from code written in any suitable computer-programming language, including, for example, C, C++, C #, Perl, Java, Python, etc.

In some examples, the memory 707 can include computer program instructions 710 that can be executed by the processor 704 to perform various operations. For example, the computer program instructions 710 can include instructions that, when executed, can cause the processor 704 to perform the allocation process. Additionally, or alternatively, the computing device 702 can include a power source 720, which can be in electrical communication with the computing device 702 and the communications device 701 (e.g., an RF chain that includes one or more antennae 728, amplifiers, analog to digital converters, digital to analog converters, filters, etc.). In some examples, the power source 720 can include a battery, or a suitable electrical cable, and can include an AC signal generator. The computing device 702 can operate the power source 720 to apply a transmission signal to an antenna 728 to generate electromagnetic waves that convey data relating to the approximations to other systems. For example, the computing device 702 can cause the power source 720 to apply a voltage with a frequency within a specific frequency range to the antenna 728. This can cause the antenna 728 to generate a wireless transmission. In other examples, the computing device 702, rather than the power source 720, can apply the transmission signal to the antenna 728 for generating the wireless transmission.

The computing device 702 can additionally include an input/output interface 732, which can connect to a keyboard, pointing device, display, touchscreen, and/or other suitable computer input/output devices. Input can be provided using the input/output interface 732. Data relating to the allocation process and charging resources can be displayed via the input/output interface 732.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

While the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

What is claimed is:

1. A system comprising:
a processor; and
a non-transitory computer-readable medium comprising instructions executable by the processor to configure the system to:
receive a plurality of charging requests from a plurality of electric vehicle coalitions;
determine, for each coalition of the plurality of electric vehicle coalitions, a score for the coalition;
determine, for a first coalition of the plurality of electric vehicle coalitions and based on a corresponding score, that a charging permission for the first coalition is acceptable;
allocate charging resources based on determining that the charging permission for the first coalition is acceptable;
enable a charging service to the first coalition by controlling the charging resources; and
adjust the corresponding score.

2. The system of claim 1, wherein the system is further configured to execute a smart contract on a blockchain network, the smart contract operable to automatically facilitate, validate, and record the plurality of charging requests and resource allocation interactions to provide a tamper-proof, auditable, and transparent record of charging events.

3. The system of claim 1, wherein the score for each coalition of the plurality of electric vehicle coalitions is computed based on historical behavior of coalition vehicles in attending scheduled charging sessions and prior completion rates of charging interactions, and wherein the score is dynamically updated after each charging event to reflect coalition behavior.

4. The system of claim 1, wherein the system is further configured to divide a geographic area of interest into a plurality of spatial zones in which each zone is associated with a local aggregator node, and wherein the plurality of charging requests and resource allocations are processed locally within each zone using zone-specific interactions to optimize the charging resources.

5. The system of claim 4, wherein the system is further configured to integrate real-time grid data, traffic data, and mobility patterns into allocation and routing decisions for the charging resources to dynamically respond to changes in charging requests across the plurality of spatial zones.

6. The system of claim 1, wherein the system is further configured to provide a matching algorithm to enable the plurality of electric vehicle coalitions to be formed, wherein the matching algorithm comprises:
generating a preference list of potential coalition vehicles based on utility functions using input comprising coalition size, scores, and aggregate energy requests; and
iteratively updating coalition vehicles according to mutual preferences until stable coalitions are established as the plurality of electric vehicle coalitions.

7. The system of claim 1, wherein the charging resources comprise a mobile charging station having a vehicle equipped with at least one battery reserve and a plurality of charging ports, the mobile charging station operable to concurrently provide charging services to multiple electric vehicles within a coalition of the plurality of electric vehicle coalitions, and wherein the system is further configured to allocate the charging resources such that a charging capacity of the mobile charging station is not exceeded.

8. The system of claim 1, wherein the system, after enabling the charging service to the first coalition by controlling the charging resources, is configured to automatically adjust a score of each coalition member of the first coalition by: incrementing the score upon successful charging completion or decrementing the score otherwise.

9. The system of claim 1, wherein the system is configured to be deployed on a consortium blockchain associated with a plurality of pre-authorized aggregator nodes, each aggregator node of the plurality of pre-authorized aggregator nodes responsible for processing charging requests and recording interactional data within its assigned zone to achieve distributed consensus without a centralized authority.

10. The system of claim 1, wherein the system is further configured to employ a repeated single-minded bidder (R-SMB) reverse process by receiving sealed requests for charging services, wherein the sealed requests are encrypted using a hashing function and revealed only after a predetermined period.

11. The system of claim 1, wherein the system is configured to dynamically allocate the charging resources between mobile charging stations and fixed charging stations based on real-time availability, capacity, and proximity.

12. The system of claim 1, wherein the system is further configured to:
receive encrypted charging requests;
perform decryption and verification on the encrypted charging requests using cryptographic keys; and
execute resource allocation logic to assign the charging resources to coalitions in accordance with smart contract rules.

13. A method comprising:
receiving a plurality of charging requests from a plurality of electric vehicle coalitions;
determining, for each coalition of the plurality of electric vehicle coalitions, a score for the coalition;
determining, for a first coalition of the plurality of electric vehicle coalitions and based on a corresponding score, that a charging permission for the first coalition is acceptable;
allocating charging resources based on determining that the charging permission for the first coalition is acceptable;
enabling a charging service to the first coalition by controlling the charging resources; and
adjusting the corresponding score.

14. The method of claim 13, further comprising executing a smart contract on a blockchain network to automatically facilitate, validate, and record the plurality of charging requests and resource allocation interactions to provide a tamper-proof, auditable, and transparent record of charging events.

15. The method of claim 13, further comprising dividing a geographic area of interest into a plurality of spatial zones in which each zone is associated with a local aggregator node, and wherein the plurality of charging requests and resource allocations are processed locally within each zone using zone-specific interactions to optimize the charging resources.

16. The method of claim 15, further comprising integrating real-time grid data, traffic data, and mobility patterns into allocation and routing decisions for the charging resources to dynamically respond to changes in charging requests across the plurality of spatial zones.

17. The method of claim 13, further comprising providing a matching algorithm to enable the plurality of electric vehicle coalitions to be formed, wherein the matching algorithm comprises:
generating a preference list of potential coalition vehicles based on utility functions using input comprising coalition size, scores, and aggregate energy requests; and
iteratively updating coalition vehicles according to mutual preferences until stable coalitions are established as the plurality of electric vehicle coalitions.

18. The method of claim 13, further comprising automatically adjusting, after enabling the charging service to the first coalition by controlling the charging resources, a score of each coalition member of the first coalition by: incrementing the score upon successful charging completion or decrementing the score otherwise.

19. The method of claim 13, further comprising dynamically allocating the charging resources between mobile charging stations and fixed charging stations based on real-time availability, capacity, and proximity.

20. A non-transitory computer-readable medium comprising instructions executable by a processing device to cause the processing device to:
receive a plurality of charging requests from a plurality of electric vehicle coalitions;
determine, for each coalition of the plurality of electric vehicle coalitions, a score for the coalition;
determine, for a first coalition of the plurality of electric vehicle coalitions and based on a corresponding score, that a charging permission for the first coalition is acceptable;
allocate charging resources based on determining that the charging permission for the first coalition is acceptable;
enable a charging service to the first coalition by controlling the charging resources; and
adjust the corresponding score.
